(19) United States
(12) Patent Application Publication
(10) Pub. No.: US 2016/0169386 A1
(43) Pub. Date: Jun. 16, 2016

(54) MASTER CYLINDER PRIMARY PISTON

(71) Applicant: ROBERT BOSCH GMBH, Stuttgart (DE)

(72) Inventors: Marc Rodriguez, Beverley Hills, MI (US); Daniel Grech, Lamorlaye (FR); Laurent Lhuillier, Le Blanc Mesnil (FR)

(21) Appl. No.: 14/902,767

(22) PCT Filed: Jun. 23, 2014
(86) PCT No.: PCT/EP2014/063144

§ 371 Date: Jan. 4, 2016

(30) Foreign Application Priority Data
Jul. 2, 2013 (FR) 1356428

(51) Int. Cl. F16J 1/00

(52) U.S. Cl. CPC F16J 1/005

(57) ABSTRACT

A tandem master cylinder primary piston, includes a tandem master cylinder primary piston arrangement formed from a body equipped with a skirt and separating the rear of the primary piston on the pushrod side from the front, turned toward the primary chamber, this front cavity housing the return spring and its telescopic guide, one extremity of the spring resting against the back of the front cavity and, the other extremity, against an exterior flange of the telescopic guide, in which the piston is of plastic material, and in which the guide of the return spring is formed of a retention sleeve equipped with a flange for support of the front of the return spring, and a headed rod passing through the sleeve and, when extended, retained by its head against the back of the sleeve, the rod being screwed to the back of the front cavity of the primary piston.

### FIELD OF THE INVENTION

The present invention relates to a tandem master cylinder primary piston formed from a body equipped with a skirt and separating the rear of the primary piston, on the push rod side, from the front, turned toward the primary chamber, this front cavity housing the return spring and its telescopic guide, one extremity of the spring resting against the back of the front cavity and, the other extremity, against an exterior flange of the telescopic guide.

### BACKGROUND INFORMATION

In general, such primary pistons are believed to be understood. One example is shown in the axial cutaway of FIG. 1. Primary piston 401 is movable along the direction of axis xx, which is that of the borehole of the master cylinder in which it moves. Primary piston 401 consists of body 411, externally equipped with skirt 412 with the diameter of the bore hole of the master cylinder. According to the customary conventions for orientation of a tandem master cylinder and its pistons, the rear (AR), located on the right, is turned toward the pushrod, connected to the brake control organ, for example, the brake pedal. The other side is the front (AV).

This orientation convention will be used in the present description.

The body of piston 411 thus forms rear cavity 413, which receives, for example, the plunger piston, which is itself actuated by the pushrod connected to the brake pedal, these different elements not being shown. In front, the body delimits the skirt, a portion of primary chamber 414. This forward cavity houses return spring 402, which rests against the secondary piston, not shown, which would be located to the left of the figure. This return spring 402 is equipped with telescopic guide 403, formed of first sleeve 431, sliding in second sleeve 432, and affixed to the back of front cavity 414, first sleeve 431 terminating on the front side in support flange 4311 for return spring 402, whose other extremity makes contact with exterior edge 4321 of sleeve 432.

The rear extremity of first sleeve 431 is formed of two elastic branches 4312, terminated by hook 4313, which freely hooks against return 4322 on the front of second sleeve 432, delimiting the passage traversed by first sleeve 431. The two branches 4312 of first sleeve 431 can approach one another elastically so that this extremity can be introduced into sleeve 432 and subsequently hook behind the return. Sleeve 431 can slide in large diameter sleeve 432, depending on the compression of return spring 402.

This return spring 402 does not directly exert any force on the primary piston but simply produces the extension of the small sleeve with respect to the large sleeve.

This primary piston, to which the guide bearing the return spring is attached, has a complex structure, affecting both the manufacture of the individual parts as well as their assembly.

### SUMMARY OF THE INVENTION

The present invention has as its object the development of an economically configured primary piston.

To that end, the object of the invention is a tandem master cylinder primary piston of the type described above, characterized in that the piston is of plastic material and the return spring guide is formed from a retainer sleeve equipped with a flange to support the front of the return spring and a headed rod passing through the sleeve and held by its head when extended against the back of the sleeve, the rod being screwed to the back of the front cavity of the primary piston.

The realization of this primary piston configuration is especially economical due to the plastic structure of the body and skirt of the primary piston and the spring guide.

According to a particularly advantageous characteristic, the piston is made of a fiber filled phenolic resin. The piston thus realized has the advantage of having a coefficient of thermal expansion close to that of the aluminum of the master cylinder body.

According to another advantageous characteristic, the body of the primary piston has, along its axis, a threaded boss, and the rear extremity of the headed rod is equipped with corresponding threads for screwing into these tapped threads in the piston body, which allows for especially simple assembly.

According to another advantageous characteristic, the body of the primary piston has, in its front cavity, a threaded end and the headed rod has a rear extremity equipped with tapped threads so it can be screwed onto the threaded end.

This solution also has the advantage of considerably simplifying piston assembly.

According to another advantageous characteristic, the back of the sleeve has a return delimiting a passage, and the headed rod has a circular head whose diameter is less than the interior diameter of the sleeve and greater than the passage at the bottom of the sleeve.

Thus, overall, the piston with the characteristics described above, can be realized simply and economically. Its assembly is equally simple and its operation is perfectly suited to the master cylinder because the coefficients of expansion are similar.

The present invention will be described below in greater detail by examples of an embodiment of a primary piston of a tandem master cylinder according to the invention, shown in the attached drawings.

### BRIEF DESCRIPTION OF THE DRAWINGS

FIG. 1 is an axial cutaway of a primary piston according to the state of the art.

FIG. 2 is an axial cutaway of a first embodiment of a primary piston according to the invention.

FIG. 2A is a profile view of the first embodiment of the primary piston and spring guide, detached from one another but without showing the spring.

FIG. 3 is an axial cutaway of a second embodiment of a primary piston according to the invention.

FIG. 3A is an axial cutaway of a second embodiment, the spring guide being detached from the piston, without the return spring.

FIG. 4 is an enlarged view of the threaded boss of the primary piston of FIG. 3.

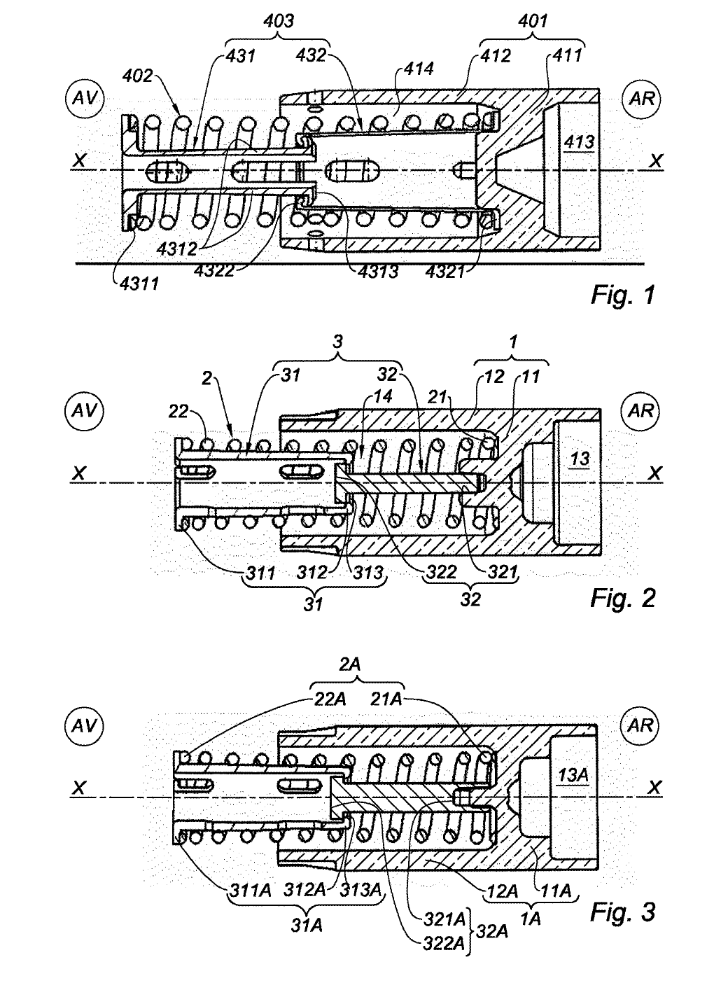

### DETAILED DESCRIPTION

FIG. 2 shows a first embodiment of a primary piston according to the invention. This piston 1 consists of body 11 having skirt 12 and delimiting rear cavity 13 to receive the plunger piston and extremity of the pushrod, and front cavity 14, delimiting the primary chamber and receiving return spring 2 equipped with spring guide 3, formed of front sleeve 31 and headed rod 32, telescopically associated with front sleeve 31. Headed rod 32 has threads 321 at its rear extremity so it can be screwed into tapped threads 112 in axial boss 111, which protrudes beyond the back of front cavity 14. Front sleeve 31 is equipped, on the front side, with external flange 311 and, on the rear side, with a return or internal flange 312, delimiting axial passage 313 traversed by rod 32, whose head 322 at the end opposite the threaded extremity, is shaped like a circular disk of smaller cross-section than the interior cross-section of front sleeve 31 but clearly greater than the cross-section of passage 313 in the back of the sleeve so that it can be retained by return 312 in its extended position. Spring guide 3 is engaged in return spring 2, whose extremity 21 rests against the back of cavity 14 around boss 111 to which is affixed the rear extremity of rod 32, and whose forward extremity 22 rests against front flange 33 of sleeve 31.

It should be noted that in this embodiment, the front portion of skirt 12 does not contain an orifice for hydraulic fluid so the primary chamber can be filled when the primary piston is in rest position, as is generally known for tandem master cylinders, rather, here, front edge 121 of skirt 12 has reduced thickness 122 to create a free space with respect to the borehole in the master cylinder, thereby allowing the passage of hydraulic fluid whenever the primary piston is in rest position.

FIG. 2A is an axial cutaway of the primary piston and its return spring guide but does not show the spring.

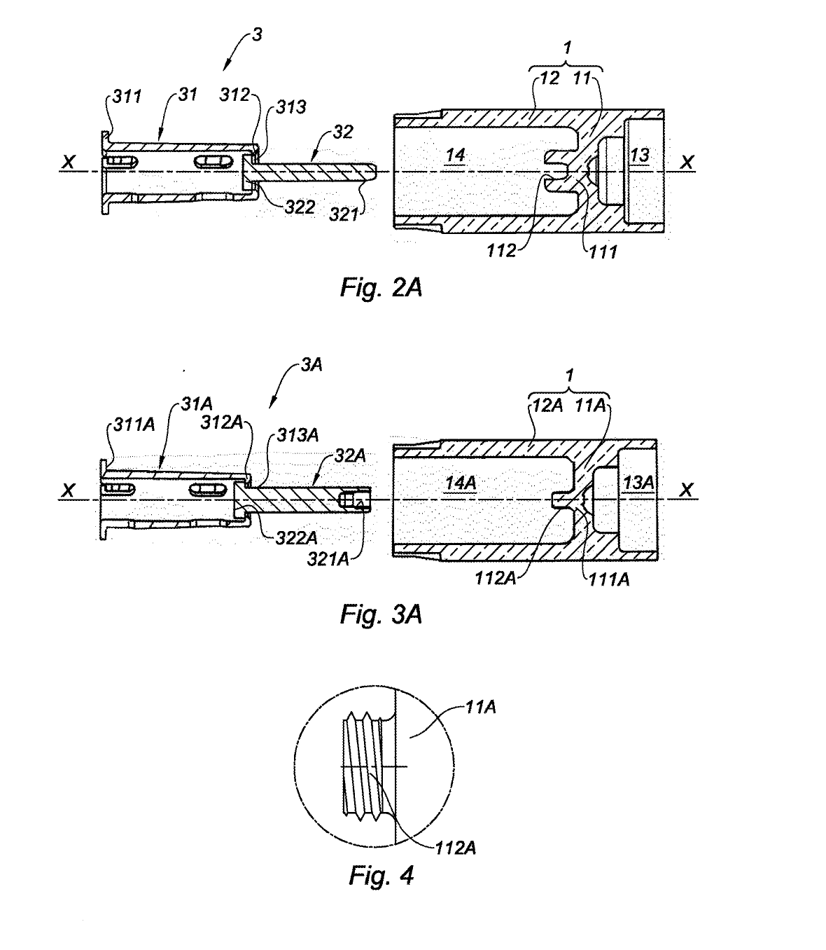

FIG. 3 shows a second embodiment of the primary piston of the tandem master cylinder according to the invention, also shown in an axial cutaway. This second embodiment differs from the first embodiment primarily in the way spring guide 3A is assembled on body 11A of primary piston 1A.

Spring guide 3A consists of two parts, front sleeve 31A, equipped in front with flange 311A serving as a support for front extremity 22A of return spring 2 and receiving, in its interior, headed rod 32A, retained by return 312A on the back of the sleeve bordering passage 313A, traversed by headed rod 32A, whose head, 322A, is retained against this return inside sleeve 31A.

The rear extremity of headed rod 32A, whose cross-section is greater than that of the first embodiment, is provided with axial tapped threads 321A. Body 11a of piston 1A has, in axial position, protruding from the back of the front cavity, threaded boss 112A, so that the rear extremity of headed rod 32A can be screwed to this threaded boss and spring guide 3A attached to piston 1A.

In this case, as well, extremity 22A of return spring 2A rests against external flange 311A of sleeve 31A and, the other extremity 21A rests against the back of front cavity 14A.

FIG. 3A is an axial cutaway of the second embodiment of the primary piston and the guide for its return spring without the return spring.

FIG. 4 is a detailed representation of the threading of the boss of FIG. 3.

Advantageously, the primary piston is made of a fiber filled phenolic resin. This resin, which is a thermohardening plastic resin, has the advantage of having a coefficient of expansion close to that of aluminum, material out of which the master cylinder is made.

### REFERENCE KEY

1, 1A Primary piston
2, 2a Return spring
Return spring guide
11, 11A Body
111, 111A Boss
112, 112A Axial threading of the boss
12, 12A Skirt
13 Rear cavity
14 Primary chamber
21 Rear extremity of the return spring
22 Front extremity of the return spring
31 Sleeve
311 External flange
312 Internal flange
313 Passage delimited by the internal flange
32 Headed rod
321, 321A Threaded end of the headed rod
322, 322A Head of rod
401 Known primary piston
411 Body
412 Skirt
413 Rear cavity
414 Front cavity/primary chamber
402 Return spring
403 Telescopic guide
431 First sleeve
4311 Front flange
4312 Branch
4313 Hook
432 Second sleeve
4321 Flange
4322 Return

1-5. (canceled)

6. A tandem master cylinder primary piston, comprising:
a tandem master cylinder primary piston arrangement formed from a body equipped with a skirt and separating the rear of the primary piston on the pushrod side from the front, turned toward the primary chamber, this front cavity housing the return spring and its telescopic guide, one extremity of the spring resting against the back of the front cavity and, the other extremity, against an exterior flange of the telescopic guide;
wherein the piston is of plastic material, and
wherein the guide of the return spring is formed of a retention sleeve equipped with a flange for support of the front of the return spring, and a headed rod passing through the sleeve and, when extended, retained by its head against the back of the sleeve, the rod being screwed to the back of the front cavity of the primary piston.

7. The master cylinder primary piston of claim 1, wherein the body of the primary piston has, along its axis, a boss with tapped threads, and the rear extremity of the headed rod is equipped with corresponding threads for screwing into these tapped threads in the body of the piston.

8. The master cylinder primary piston of claim 1, wherein the front cavity of the body of the primary piston has a threaded boss and the headed rod has a rear extremity with tapped threads so it can be screwed onto the threaded boss.

9. The master cylinder primary piston of claim 1, wherein the back of the sleeve has a return delimiting a passage, and the headed rod has a circular head whose diameter is less than the interior diameter of the sleeve and greater than the passage at the back of the sleeve.

10. The master cylinder primary piston of claim 1, wherein the piston is made of a fiber filled phenolic resin.
